(19) United States
(12) Patent Application Publication
(10) Pub. No.: US 2009/0281854 A1
(43) Pub. Date: Nov. 12, 2009

(54) Interactive knowledge sales market database

(76) Inventor: Michael C. Chappen, Atlanta, GA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/453,359

(22) Filed: May 7, 2009

Related U.S. Application Data
(60) Provisional application No. 61/071,592, filed on May 7, 2008.

(51) Int. Cl. G06Q 40/00; G06Q 10/00; G06Q 20/00; G06Q 30/00

(52) U.S. Cl. 705/7; 705/30; 705/14.72; 705/37

(57) ABSTRACT

The interactive knowledge sales market database is organized into four cooperating peer systems. The database system includes an advertisement broadcast system, for catering to individual creativity and innovation via user-customizable formatting and creation of advertisements, a distribution implementation system for distributing the advertisement to a market community, a member interaction system for providing a virtual, online marketplace to the users, and an economic exchange system that accounts for all exchanges in the market community via electronic fund transactions. All systems are linked to a common market database, which has a tiered software architecture for directly supporting the four systems and providing a market exchange of innovation insights, outlooks, ideas, tips, and thought to Internet users utilizing the interactive knowledge sales market database.

### CROSS-REFERENCE TO RELATED APPLICATION

This application claims the benefit of U.S. Provisional Patent Application Ser. No. 61/071,592, filed May 7, 2008.

### BACKGROUND OF THE INVENTION

1. Field of the Invention

The present invention relates to an electronic market of knowledge-based information, and, more specifically, towards an interactive, online knowledge sales market database in which website members advertise, sell and buy knowledge-based information.

2. Description of the Related Art

Knowledge can be defined as “awareness or familiarity gained by experience of a fact of situation,” or as “confident understanding of a subject with the ability to use it for a specific purpose if appropriate.” Knowledge exchange and access is the primary purpose of the Internet. Nevertheless, cyberspace remains an infinitely large storage container of knowledge incapable of being fully occupied. Consequently, while “X” represents all of the knowledge currently or previously entered and stored in cyberspace (i.e., in the global database formed by the Internet and the World Wide Web), “Y” represents the absent knowledge and the infinite potential of expansion (i.e., what is not available to users of the Internet). Using these representations, X+Y would represent all of the available knowledge in our society, with Y being far greater than X.

Differentiating between X and Y is relatively simple. Disregarding the portion of X represented by pornography, gambling and other non-knowledge and information-based uses of the Internet, the overflow represents available knowledge rooted in Internet-user incentive. While the authors of X were inspired by an incentive to contribute to the general knowledge pool of cyberspace, the originators or bearers of Y, conversely, were not. Whether incentive is remunerative (i.e., financially-based), moral or coercive, incentive inspires human behavior. Forfeiting knowledge to cyberspace is a behavior also inspired by incentive. What remains as unrecorded in the global database, represented by Y, is potentially innovative and original. Thus, there is need to provide incentive to the bearers of information Y, such that Y can be added to the global database of the Internet.

Currently, those who hold the unrecorded knowledge and information retain potentially valuable knowledge, with the knowledge not benefiting anyone. Such Internet users only take from cyberspace, without contributing to the global knowledge database. These users invest their web “surfing” time in entertainment, hobbies, sports, leisure, etc. They represent, unfortunately, the average Internet user. Such users are the audience and customers (buyers) of web services supported by the authors of X. They represent the vast, non-profiting user base that feeds money into the Internet market.

Despite its primary purpose of knowledge exchange, the Internet has succumbed to profiteers. With the exception of a small “Good Samaritan” user base that contributes valuable knowledge for the free benefit of the Internet community, financial incentive dictates the extent and quality of knowledge exchange in cyberspace. Multiple markets within cyberspace, such as travel, entertainment, retail, real estate, etc., provide specific knowledge and information oriented toward the service of their respective websites. Meanwhile, the “common man”, non-market-specific knowledge remains alive in the minds of non-contributors.

A need exists to fill the space of Y, with the presently non-contributing bearers of useful information given the chance to turn their knowledge into a product. A market exchange is needed that will promote innovation, originality and a new level of human interaction and communication within the amateur Internet user base. Additionally, it would be desirable to provide the users of an online market exchange with the virtual look, feel and experience of an actual marketplace. In addition to offering financial incentives, providing a pleasant virtual environment will encourage the recordation and exchange of previously unstored and untraded information. Thus, an interactive knowledge sales market database solving the aforementioned problems is desired.

### SUMMARY OF THE INVENTION

The interactive knowledge sales market database is based on a distributed architecture where components are distributed across multiple computers and are organized into four cooperating peer systems. An advertisement broadcast system (ABS) serves as a high-level interface, catering to individual creativity and innovation by transforming advertisements into Uniform Resource Locators (URLs) referencing external domains accessible by hyperlinks. A distribution implementation system (DIS) translates the advertisement into distribution by implementing a disclosure marketing mechanism, disclosing the advertisement to a market community. A member interaction system (MIS) simulates interaction by technological, Internet-friendly devices by catering to sights and sounds. Finally, an economic exchange system (EES) accounts for all exchanges in the market community.

To connect the systems together, a communications bus is provided for flowing information between the advertisement broadcast system, the distribution implementation system, the member interaction system, and the economic exchange system. Each of the four systems also shares a common overall structure, which is designed to be distributable, modular, and capable of external and internal communication across the communication bus.

The common overall structure includes a master application for starting, stopping, and monitoring overall conditions of each of the respective systems, and a components manager for managing operation of specific components found in each of the respective systems. Connected to all the systems is a market database. The market database has a tiered software architecture. The software has high-level applications and tools for directly supporting the four systems.

The software architecture includes a service layer for implementing mid-level functionality in the four systems, and core tools for building low-level functionality in the four systems. Finally, the market database includes base tools for supporting open source software.

The system is preferably accessed through the Internet or any other suitable network. Remote user terminals, which may be home computers or the like, communicate with a central server via any suitable type of network, such as the Internet or a local area network. The server includes at least a processor, which is in communication with computer readable memory and a display and interface. A Market Database is stored within the computer readable memory, as is the overall software architecture, which forms the ABS, the DIS, the EES and the MIS.

The system, by providing an online, virtual marketplace, allows users to store knowledge-based data in the Market Database, and form advertisements (via the ABS) for the knowledge-based data, with the advertisements including hyperlinks back to the system. The DIS distributes these advertisements, including the hyperlinks, across the network (which may be the Internet or World Wide Web), and those interested in purchasing the knowledge-based data may click the appropriate hyperlink to be taken to the system, where they may choose to purchase the knowledge-based data. The MIS provides a simulated, virtual marketplace environment, including video and audio, allowing the respective buyers and sellers to interact through virtual social networking, and the EES provides a secure transaction system, allowing for the electronic transfer of funds.

It should be noted that users may provide information for sale, or may also choose to provide free information. Free information, as well as publicly disclosed information (such as a user's feedback or approval rating) is provided to members and non-members without exchange of currency. The knowledge-based information which is for sale may ultimately only be accessed via a transfer of funds through the EES.

Upon registration, members of the system have the ability to provide free information, in a manner similar to the posting of most presently available Internet content, or to store information, which is for sale, via the ABS. Information exchange, social networking, and searching of information, as are presently known in the broader Internet community, all take place within the virtual marketplace of the system.

These and other features of the present invention will become readily apparent upon further review of the following specification and drawings.

### BRIEF DESCRIPTION OF THE DRAWINGS

FIG. 1 is a block diagram of an interactive knowledge sales market database according to the present invention.

FIG. 2 is a block diagram of the architecture of a cooperating peer system in the interactive knowledge sales market database according to the present invention.

FIG. 3 is block diagram of the software architecture of the interactive knowledge sales market database according to the present invention.

FIG. 4 and FIG. 5 are a flowchart of the interactive knowledge sales market database according to the present invention.

FIG. 6 is a diagrammatic view of the overall system architecture of the interactive knowledge sales market database according to the present invention.

Similar reference characters denote corresponding features consistently throughout the attached drawings.

### DETAILED DESCRIPTION OF THE PREFERRED EMBODIMENT

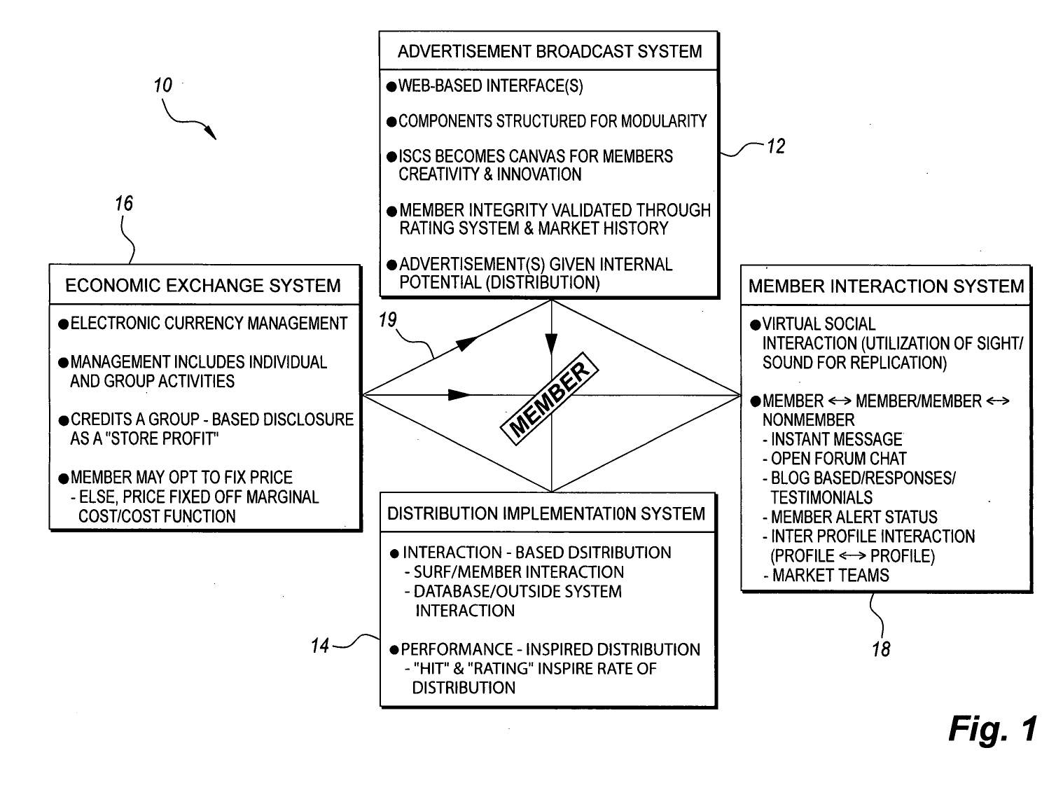

As shown in FIG. 1, the present invention is an interactive knowledge sales market database with a Knowledge Free Market Exchange (KFME) software system 10 that is a highly-distributable, client-server system.

In general, the KFME 10 is based on a distributed architecture with components distributed across multiple computers. These computers are connected using any suitable type of computer network, including local area networks (LANs), such as an Ethernet system, or a wide area network (WAN). Preferably, these networked computers are treated as interchangeable and, unless dictated by hardware requirements, no specific task is required to run on any one specific computer. A fundamental precept of this architecture is that all software components are individually accessible from any other component, unless access is explicitly restricted. The extent to which this accessibility is organized (hierarchically or otherwise) and how access is restricted are properties of the system design, and not the infrastructure.

Components are the basic building blocks of the system's distributed architecture, and the concept of a component is used as an architectural foundation. A goal of this baseline architecture is to isolate hardware-specific operations within small components, thus increasing system flexibility. “Devices” are components with direct access to a device driver. For this reason, the architecture distinguishes between software devices and device drivers. Software devices are the smallest addressable components in the system. Device drivers are software components whose operating environments are physically constrained in some manner.

With reference to FIG. 1, the system 10 is organized into four cooperating peer systems: the Advertisement Broadcast System (ABS) 12, the Distribution Implementation System (DIS) 14, the Economic Exchange System (EES) 16, and the Member Interaction System (MIS) 18. Each of these major systems is responsible for different aspects of free market operations.

The ABS 12 serves as a high-level interface that caters to individual creativity and innovation via cemented component modularity, which permits continuous device upgrades. At its highest level, the ABS 12 transforms member advertisement(s) into client URLs that invite themselves into external domains in a name of member disclosure marketing. For example, member advertisement becomes accessible through outside entity “jump links”, such as search engine results, etc. Consequently, the ABS 12 is strongly rooted in an effectiveness of a distribution implementation function.

The ABS 12 provides a user-friendly system, including easy-to-use templates, allowing members to enter knowledge-based information disclosures, preview the entered data and be easily led through a user interface, step by step, with a plurality of options. The ABS 12 caters to member creativity and innovation through technological compatibility and modularity. For example, a member may opt to advertise his information disclosure by uploading a home video including a nested sound byte demonstrating and explaining its effectiveness. Thus, there is an advertisement function having a segment of code that allows the user to manifest his product through outside technological devices, (e.g., image uploads, video uploads, blue tooth capability, word/notepad type entries, graphs, charts, animation, etc.), where the code is adaptive to member originality and innovation in the advertisement of his knowledge. The ABS 12 allows a user to easily enter his or her particular knowledge-based information as data to be sold, with the ABS 12 providing an interface for entering the data, and for advertising the data, which the user wishes the sell. Providing templates for the storage of information in databases using a user-friendly interface, and the conversion of such information into advertising media, is well known in the art of Internet and World Wide Web advertising, and any suitable system and method may be utilized by the ABS 12.

In general, the DIS 14 translates member advertisement (entered and formed by the ABS 12) into member distribution. Accordingly, the DIS 14 provides a large portion of the complete market experience for members (pending “seller” status) by implementing a disclosure marketing mechanism (with “marketing” being defined as the coupling of advertisement and distribution). The measure of DIS 14 effectiveness is related to seller “hits” and market “visits” associated with outside entity “jump links”; i.e., the DIS 14 provides a means for distributing the advertisement of the user's knowledge, formed by the ABS 12, across the World Wide Web, with ads being positioned on other websites and web portals. The DIS 14 may include a measure of effectiveness, wherein the number of “clicks” on the distributed ads (provided as “jump links” on these other websites and web portals) are counted and measured.

Using these measured statistics, the availability of the user's advertising, as well as the availability of the knowledge the advertisements represent, may increase based upon increasing numbers of measured “clicks”. The DIS 14 is flexible with respect to member success, which measured by hit (or click) count and average approval rating, where increased member success will potentially lead to increased availability on the World Wide Web. Coupled with individualized advertisement, the DIS 14 equips members with “seller” status with complete marketing potential. Using system 10, the member joins the overall system, which provides access to the ABS 12 and the DIS 14, preferably paying to become a member, and once the information has been entered into the ABS 12 and an advertisement is ready for distribution by the DIS 14, the user may achieve “seller” status, allowing the release, or distribution, of the seller's advertisements. Posting advertisements with measured click counts is well known in the art of Internet and World Wide Web technology, and any suitable distribution system for advertising links may be utilized by the DIS 14.

A distribution function includes a segment of code that effectively discloses member advertisement to the market community. The function has the possibility of expanding, nesting and branching within and outside the market community. For example, member distribution may eventually (or initially) be linked to outside search engines, outside knowledge-specific entities, etc. Furthermore, members may initially or potentially opt to establish specific customer relationships and groupings based on community feedback and response. In the same manner, members may opt to strategically distribute their disclosed knowledge in a way that targets or isolates certain sects of the market community. The possibilities of distribution must ultimately remain flexible. Targeted advertising methods are well known in the art of Internet and World Wide Web marketing, and any suitable method of targeting advertising may be utilized.

The MIS 18 simulates, through limited human senses (including sight and sound), typical 360° interaction found in standard physical markets; i.e., the MIS 18 provides a virtual marketplace with graphical and acoustic representations provided to the user, over the Internet or other computer network, of typical human interaction found in physical marketplaces. As a result, the MIS 18 simulates member-to-member (seller-to-seller, buyer-to-buyer, and seller-to-buyer), non-member-to-member (shopper-to-seller or shopper-to-buyer), non-member-to-product (shopper-to-product), and member-to-product (buyer-to-product or seller-to-product) interactions. Typical interactions found in standard physical markets are replicated via technological, Internet-friendly devices catering to sights and sounds that best portray the physical realm.

Consequently, the MIS 18 is closely centered on modularity and compatibility with technological advances involving Internet-friendly devices. For example, members may be involved in video, image, and sound projections simultaneously, representative of a seller-to-shopper “sales pitch” (with advertisements generated by ABS 12 being delivered, preferably in multimedia format, to a potential buyer), seller-to-seller collaboration (creating an advertisement as a “store” for a shared disclosure using ABS 12 and DIS 14) or shopper-to-product “contact” (simulating via a graphical interface the lifting, shaking or “playing” with a physical product, for example).

The member interaction function is a segment of code that permits members within the market community to socially interact, without the exchange of electronic currency. As above, the code must be adaptive to the various, possible and potential types of non-monetary interaction that will be required for members to feel the true social interaction of a real, physical market. In the end, the code segment should assume user anonymity while allowing for the multiple possibilities of member, non-monetary interaction (such as instant messaging capabilities, etc.)

The EES 16 accounts for all exchanges in a reliable, efficient, and timely fashion. The EES 16 immediately credits sellers with buyer and shopper feedback, providing continuous “hit” and seller rating updates, along with forum-based opinions, which may be provided as part of the socio- economic factors that inclusively compose an exchange in a market-type environment. Likewise, profits are translated into electronic currency and accounted for by the EES 16. The EES 16 allows for electronic exchange of actual currency, with buyers being able to pay via credit card or the like, and with transactions, representing actual currency transfer, being represented electronically. Members may withdraw from their accounts within the EES 16, and perform any other desired financial transactions. Internet and World Wide Web-based currency exchange is well known in the art, and any suitable system for electronic currency transfer related to the buying and selling of goods or services may be utilized by the EES 16.

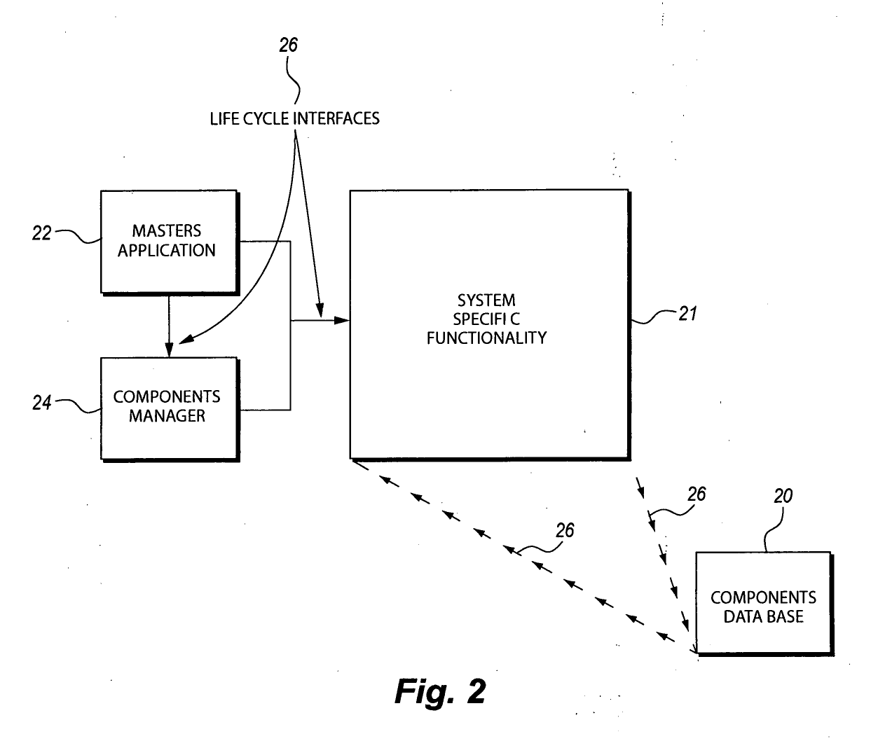

Buyers receive their respective disclosures in a user-friendly fashion that couples feasibility with. For example, buyers may wish to store their purchased disclosures in market-hosted, personal profiles. The EES 16 replicates the privilege of housing purchased products in a physical market, including buyer and seller databases for storing the knowledge-based information, both pre-purchase and post-purchase, along with the ability to utilize the stored information in accordance with its specific purpose. The EES 16 includes a financial function that is a nested code/software that electronically accounts for “money flow” inside the entity's market. The function credits paying members with their allocated advertisement/distribution opportunity. Likewise, the financial function gathers, subtracts and sends accredited profits to exiting or cashing-out members. With reference to FIGS. 1 and 2, a communications bus 20 serves as the backbone for communications. This communications bus 20 provides the information flow. Control and status information flows through the KFME control system 10 using a message-passing architecture. The types of messaging include Commands, Events, Persistent Store Access, Alarms, and Log Messages. Any suitable communications bus may be utilized.

Commands are performed using the Command/Action/Response model commonly used for standard software control designs. The fundamental entity for command processing is the “configuration”. A configuration contains all of the information necessary to move systems 12, 14, 16, or 18 from one state to another. The information in a configuration is represented by a set of attribute/value pairs. All configurations in KMFE 10 are uniquely identified and all systems 12, 14, 16, and 18 track the configuration on which they are currently operating.

The systems 12, 14, 16, and 18 respond to configurations in one of three ways: a) no response is needed. Some systems and configurations operate in a stateless manner. For example, the logging system simply accepts messages and records them with no response being required; b) an immediate action is performed and acknowledged. If the action can effectively be performed instantaneously (recording information in a local variable might be sufficient action for some configurations, like setting the debug level of a component is an example), the command response provides the result of performing that action; or c) the configuration is acknowledged as valid and an action is initiated. When the action completes, a separate mechanism, callback or event announces its completion.

As actions are being performed by one of the systems 12, 14, 16, or 18 in response to a command, the systems 12, 14, 16, or 18 may receive and generate events, make requests of the persistent stores, generate alarms, and record messages.

Events are used for asynchronous message delivery. The event system in KFME 10 is modeled after conventional notification services. Events are published/subscribed mechanisms that are based on event names. Systems 12, 14, 16, or 18 may post events without regard to the recipients and subscribe to events without regard to their source. Subscriptions may be made using wild-carded names to subscribe to multiple events sharing common name characteristics.

The systems 12, 14, 16, or 18 may store and retrieve information from the Market Database 20 (a components database). Configuration parameters for systems 12, 14, 16, or 18 are maintained in the Market Database 20 and are retrieved by the systems 12, 14, 16, or 18 on initialization. Similarly, the systems 12, 14, 16, or 18 may save checkpoint parameters into the Market Database 20 if needed. The Market Database 20 is implemented using one or more nested databases permitting searchable access to the contents. This allows other systems 12, 14, 16, or 18 to obtain, and, in the case of mangers 24, update configuration parameters. The databases in the Market Database 20 are also used to hold header information, log messages, and configuration information. Alarms are propagated using the event system. The systems 12, 14, 16, or 18 may generate alarms, respond to alarms, and recast alarms. The systems 12, 14, 16, or 18 may generate messages that are recorded into the Market Database 20.

With reference to FIG. 2, all of the four co-operating peer systems, ABS 12, DIS 14, EES 16, and MIS 18, share a common overall structure. All are designed to be distributable, modular, and capable of external and internal communication across a designated communication bus component. Likewise, all the four co-operating peer systems communicate with a market database 20 and react in accordance with its updated status. Each has a Master Application 22 responsible for starting, stopping, and monitoring the overall condition of that system's components. Each has a Components Manager 24 for managing the operation of specific components found in that system and its subsystems. The Master Application 22 and Components Manager 24 access components that provide system-specific functionality through the KFME life cycle interface 26.

These and other aspects of the common structure are discussed in the following paragraphs with particular reference to the EES 16, and FIGS. 1 and 2, since the EES 16 is responsible for maintaining the market database 20. The EES 16 provides both services and common software available for use by all principal systems 12, 14, and 18. Traditionally, user interface that is not visible is regarded as a transparent function of system design progress and is subconsciously overlooked. With regard to the total KFME 10, the market database 20 governs design progress through its continuously changing status and expansion. In the KFME 10, users (members and non-members actively involved in the market) dictate design progress through their creativity and innovation. The user interface is adaptable to reflect and meet the needs of user productivity and creativity.

Thus, the Market Database 20 acts as a virtual reflection of the user's innovation and creativity, in that its information represents user success and activity. User interface 26 communicates with the market database 20, which signifies the core status of market behavior and direction. Consequently, the EES 16 upholds a primary function of database maintenance and readiness.

The EES 16 acts as a gauge of user interface updates and improvements. Based on the context, method, and size of user-based information vaulted in the Market Database 20, the EES 16 provides an available signal of upgrades and improvements for principle systems 12, 14, and 18 via the established communication bus 19.

In its output to sister systems 12, 14, and 18, the EES 16 categorizes and flags its statistics appropriately. In turn, its sister systems 12, 14, and 18 rely on their respective modularity to update and evolve their subsystems based on EES 16 feedback. The EES 16 relies on self-maintenance, flags, and system checks to ensure consistent performance and compatibility to its sister systems 12, 14, and 18.

The overall system management relies on EES 16 subsystem management. The EES 16 executes internal maintenance that results in external maintenance for sister systems 12, 14, and 18. Management and maintenance of sister systems 12, 14, and 18 are a function of EES 16 output via the established communication bus 19. An internal algorithm regulates and organizes EES 16 output, as EES 16 output contributes directly to sister systems 12, 14, and 18 activities, updates, and upgrades.

In the same manner, EES 16 output regulates external system functionality. EES 16 output drives principal system behavior, which is regulated through respective subsystem states and activities. Accordingly, another function of the established communication bus 19 is for direct distribution of EES 16 output to sister system libraries and scopes that regulate local variables.

In view of this function, the following potential system types must be considered: Externally, some of the systems 12, 14, 16, or 18 must be started upon user entry and run until the user exits the Market Database 20. Examples of such functions are systems involved in logging, database access, and even access of the Component Manager 24 and Master Application 22. Other systems 12, 14, 16, or 18, once started, continue to operate until explicitly shut down. Most systems 12, 14, 16, or 18 within the KFME 10 system are preferably long-lived (assuming feasibility and timeliness of market updates that inspire user longevity in the market). Still, other of systems 12, 14, 16, or 18 may be designed to exist only long enough to satisfy some particular request. An example of this may be a handler to respond to a specific error condition.

In all involved systems 12, 14, 16, or 18, critical state information (including initial configuration parameters and checkpoint state) is maintained in the Market Database 20, which is maintained and accessible from outside the systems 12, 14, 16, or 18. The only exceptions to this are state information that varies too rapidly to be maintained externally, along with information that is relevant only within a single instance of the system. Some information, such as the current system health and the system's life cycle model, is required to be kept in the Market Database 20.

Market resources can potentially be modeled as infinite, particularly in the sphere of cyberspace. Acceptance of this, and the fact that the primary resource is the offered product (knowledge) and variations thereof, resources must be managed through categorization of these variations. In effect, the EES 16 is responsible for creating and upholding the criteria for categorization of these variations based on respective data stored in the systems 12, 14, 16, or 18 that classify advertisement and disclosure input. A nested database and respective algorithm contribute to this classification.

The underlying resource in the Market Database 20 is knowledge-based information. Additional resources qualify through their support of the offered product. These resources include user innovation and creativity. The EES 16 market database accounts for and manages these resources by ensuring the necessary provisions that bleed their translation into manifested disclosures and supporting advertisements. These provisions include technological upgrades and interface compatibility that enables a disclosure's respective manifestation from the onset.

The EES 16 monitors KFME 10 activity through a flagging system that responds to circumstantial market behavior(s) with flagged output that alerts respective sister systems 12, 14, and 18. The principal systems, in turn, generate alarm signals to generate corrective behavior within their nested subsystems. These subsystems consequently receive fired input and output from their mother system and the market database that guide their corrective behaviors.

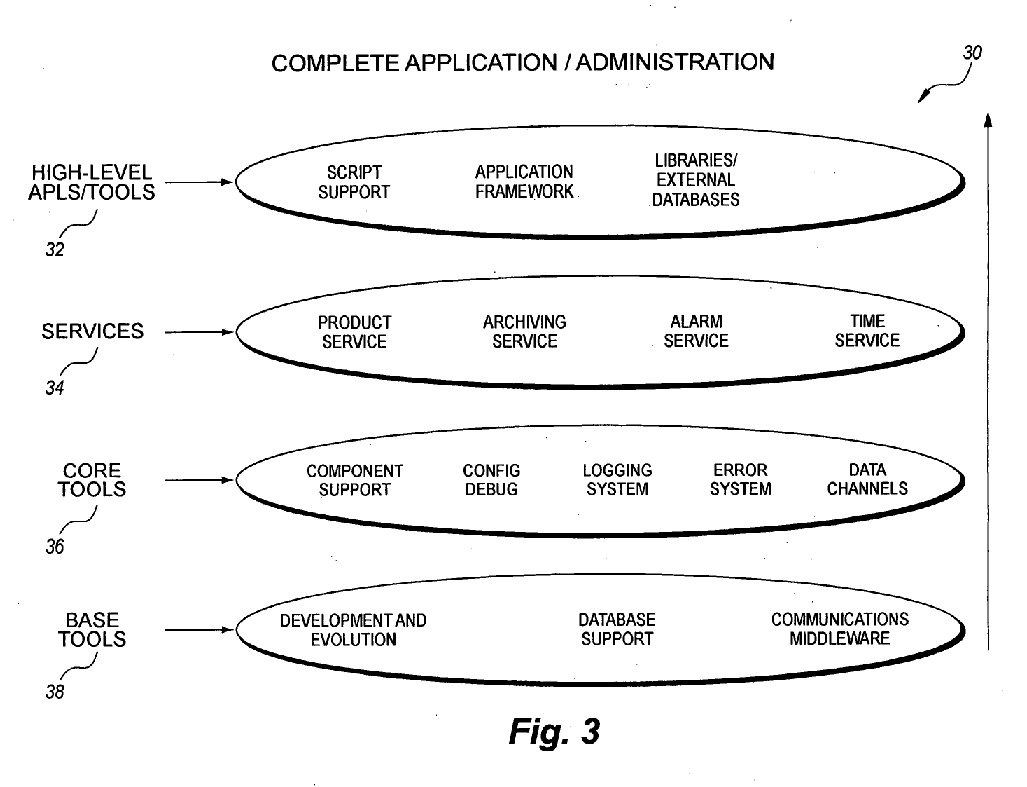

As shown in FIG. 3, the common software of the KFME system 10 is a tiered architecture 30 that nests itself in the market database roots. High-Level Applications and Tools 32 directly support the development of KFME 10 applications and represent the level presenting the common software functionality to application developers. A service layer 34 consists of software that implements mid-level KFME 10 functionality based on core tools 36. The core tools 36 build low-level KFME 10 required functionality directly from base tools 38. These core tools 36 have performance constraints that mandate direct access to the foundation software. The lowest level, the base tools 38, contains software that is independent from the actual KFME 10 functionality. The base tools 38 support software on which the KFME 10 software is based. Most of the software at the base tools level 38 is open-sourced and is not maintained by the KFME 10, but by the existing or potential user. Still, the reactionary software components are key in this respect, along with their variability and respective scopes.

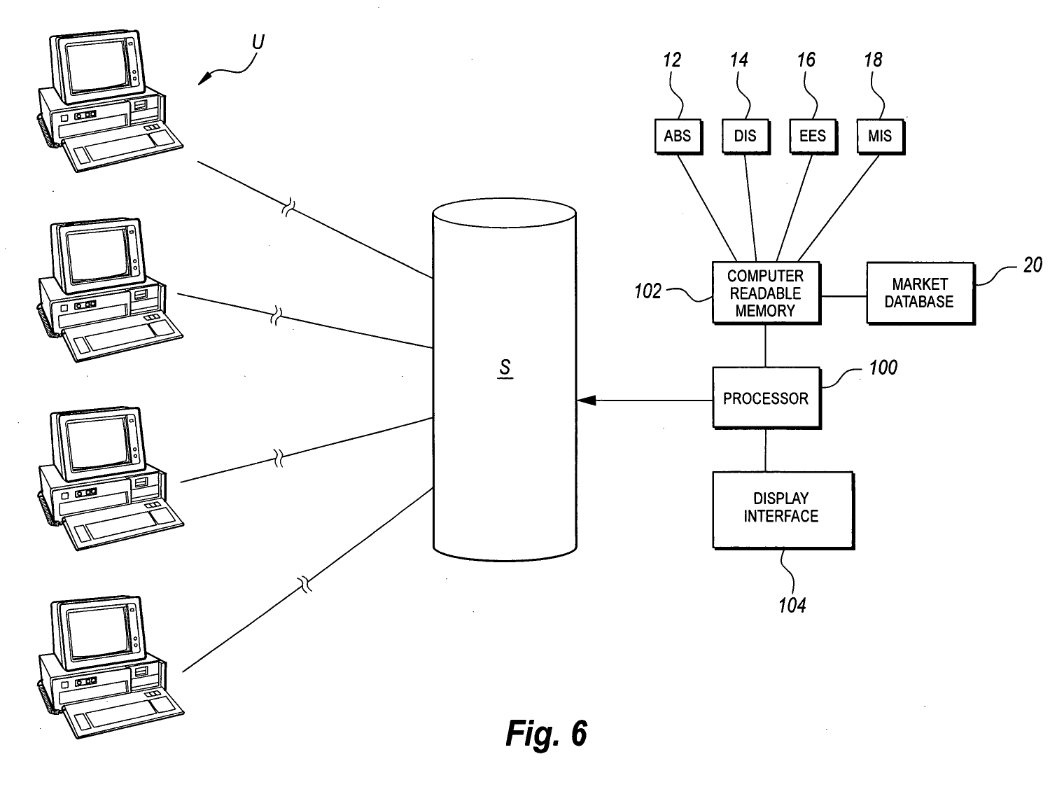

As noted above, the system 10 is preferably accessed through the Internet or any other suitable network. In FIG. 6, remote user terminals U are shown being linked to a central server S. Remote user terminals U may be home computers or the like, and communicate with server S via any suitable type of network, such as the Internet or a LAN. Server S includes at least a processor 100, which is in communication with computer readable memory 102 and a display and interface 104. The Market Database 20 is stored within computer readable memory 102, as is the overall software architecture, which forms the ABS 12, the DIS 14, the EES 16 and the MIS 18.

The system, by providing an online, virtual marketplace, allows users to store knowledge-based data in the Market Database, and form advertisements (via the ABS) for the knowledge-based data, with the advertisements including hyperlinks back to the system. The DIS distributes these advertisements, including the hyperlinks, across the network (which may be the Internet or World Wide Web), and those interested in purchasing the knowledge-based data may click the appropriate hyperlink to be taken to the system, where they may choose to purchase the knowledge-based data. The MIS provides a simulated, virtual marketplace environment, including video and audio, allowing the respective buyers and sellers to interact through virtual social networking, and the EES provides a secure transaction system, allowing for the electronic transfer of funds.

It should be noted that users may provide information for sale, or may also choose to provide free information. Free information, as well as publicly disclosed information (such as a user's feedback or approval rating) is provided to members and non-members without exchange of currency. The knowledge-based information which is for sale may ultimately only be accessed via a transfer of funds through the EES.

Upon registration, members of the system have the ability to provide free information, in a manner similar to the posting of most presently-available Internet content, or to store information, which is for sale, via the ABS. Information exchange, social networking, and searching of information, as are presently known in the broader Internet community, all take place within the virtual marketplace of the system.

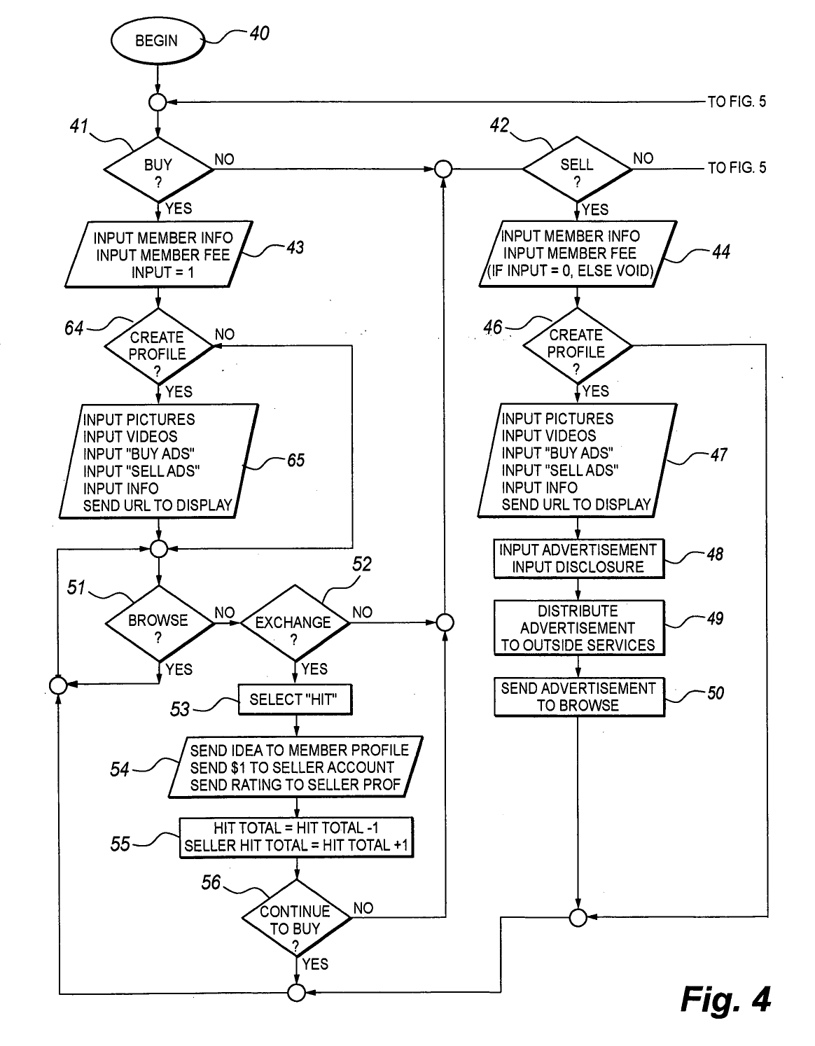

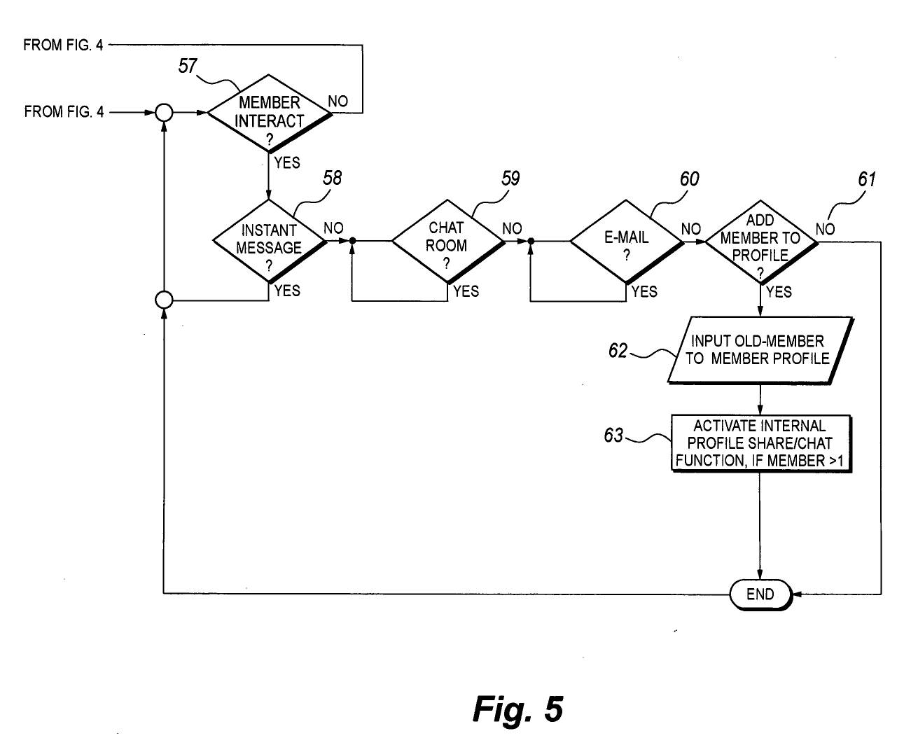

FIGS. 4 and 5 illustrate a flow diagram of the interactive knowledge sales market database according to the present invention. To demonstrate the flow diagram of the present invention, the following example is provided: Joe Smith is thirty-five years old with a wife, two kids, and a house payment. He barely makes middle-class wages and constantly strives to cut costs and save money. Although Joe recently purchased a small desktop computer on a credit card, most services would immediately disqualify him as potential seller on the Internet. Joe Smith does not appear to have a lot to sell or the time to resource a product. In addition, most would disqualify Joe Smith as a source of financial advice that would benefit a large quantity of people in similar situations.

However, unknown to most people, Joe Smith saves up to thirty dollars a month on an idea. This is an intangible idea, not a physical invention or gadget. Every two months, Joe purchases two to three car-waxing rags (“Brand X”) from a nearby auto shop. Instead of filling the cupboard space to house twelve or more rolls of paper towels every two weeks and spending fifteen dollars, he uses two or three car-waxing rags instead. Joe discovered by accident, one Sunday afternoon, that a particular type of waxing rag absorbs and cleans spills and stains as well as paper towels. The trick, according to Joe, is to wet the rag with a few squirts of his solution (½ lemon scented ammonia, ½ water in a soap dispenser stored by the sink). Moments later, he squeezes the foreign contents out of the rag and allows a few moments to dry for future use. Three rags over two months provides Joe with thirty dollars a month in savings.

In time, Joe sees an advertisement on television that catches his attention. A new website is being advertised and appeals to Joe. According to the advertisement, for a $10 fee, he can become a member with an Internet-based, open market community that provides an opportunity to disclose original knowledge for a potential profit. This is an advertisement for system 10, with the $10 fee being an initial fee required for Joe to become a member, and eventually a seller. As a sign-up bonus, the member may be afforded a free hit on another member's idea to potentially reap alternate benefits as well (i.e., rather than paying for another user's idea, Joe will be provided with the information for free).

Joe then accesses the Internet and immediately goes to a search engine. He searches “save on paper towels.” After spending several minutes searching various sites on the topic, all of which lead to dead-ends and merit nothing similar to his idea, Joe initiates the membership process at 40. The system then prompts Joe to query if he is a buyer (at 41) or a seller (at 42). The system then prompts him to input his member information at 43, 44. Since Joe is now signing up as a member, at 44, Joe pays his joining fee.

Next, the system asks if Joe wants to create a profile at 46. With the profile, Joe can input pictures, videos, and other information related to advertising his idea at 47. Joe is then prompted to input his idea at 48. Joe types a paragraph-long entry that explains his idea. The website then asks him to categorize his idea with a short summarization that advertises the benefits of this idea to other members at 49. The information Joe enters is stored by the system in the database.

Joe enters, “Tired of bulk purchases of paper towels at the sore for your family? Looking to save up to thirty dollars a month? My idea will clear your cupboards of paper towels, save room in your garage bags and keep your house clean with less hassle and money . . . ” at step 49.

Joe inputs the summarization of his idea and waits as his account is established. Shortly thereafter, his account is confirmed at 50 and Joe's initial process is completed. As Joe browses the site at step 51, Joe puts his “courtesy hit” to use. While exploring the advertisements of other members, he runs across a particular ad that catches his attention at step 52.

The ad at step 52 reads, “Are you intimidated talking in front of large crowds? Does it make your uncomfortable when all the eyes in an audience are staring at you while you speak? I have the trick that makes public speaking a little easier at work, in business, etc.!” Joe remembers that he is due to present a business proposal to his supervisors in five days. He also notices that the user has an average approval rating of 8.3 out of 10. Joe despises speaking in front of others and, thus, clicks on the entry at step 53.

The response he is provided is, “This is what I always do. It sounds real stupid but it works me. I don't know about you, but I hate making eye contact with strangers while I'm speaking to an audience. So this is what I do. I just contract my eyes a little blurry. When I take momentary pauses in my presentation to make eye contact with the audience, I do not feel uncomfortable. I know I am looking right in their eyes but I blur them out a little bit to make it easier! It sounds stupid, but trust me it works for me! You can practice blurring stuff out sitting on your couch!”

Joe initially does not find the idea appealing. While he is giving it a second glimpse, he notices that the website informs him of a mandatory prompt to rate the other member's idea in seven days at 54. Since he already used his free hit, the hit is subtracted from his total at 55. Next, he is prompted in a query as to whether he wants to continue at 56. He is prompted querying whether he wants to sell anything else (at 42), or whether he wants to interact with members (step 57, shown in FIG. 5) by instant message (58 in FIG. 5), go to a chat room (59 in FIG. 5), send e-mail (60 in FIG. 5), or add a member to his profile (61 in FIG. 5). Since Joe wants to sign- off at this time, he is brought back to the beginning (step 40) and signs off. Alternatively, he could have input an old-member to member profile at 62 or activated an internal profile share/chat function, though preferably only after his second visit (63 in FIG. 5).

The following week, Joe logs into the website at 40 to check the status of his advertisement to sell his idea. In logging in, if he selected “buy” at 41, he would have been prompted about his member information at 43, asked to create a profile at 64, and asked if he wanted to input pictures, videos, etc. at 65.

Before he is allowed entry, he is prompted to rate the previous seller on the effectiveness and quality of the idea. Joe recalls implementing the tactics in his meeting the previous Monday morning and finding it relatively successful. Consequently, he rates the idea an 8 out of 10 and proceeds to check his account. To his delight, he noticed that 16 members have hit on his idea in the last week. In addition to now having sixteen dollars stored electronically in his account, he notices that he has an approval rating of 8.7 and feels encouraged to recommend to his wife to put her candle preservation idea on the site as well.

The Internet currently offers users the opportunity to exchange knowledge and ideas with other users in a cumbersome, and time-consuming manner. The present invention capitalizes on human incentive, pride and self-interest to offer an affordable chance to from original, amateur, and day-to-day knowledge. In view of this, the overall concept is a market for original and innovative knowledge that would otherwise be absent in cyberspace.

The system provides a market exchange of innovation, insights, outlooks, ideas, tips, and thought. The system provides an opportunity for members to profit from original thought. The system is regulated with an internal rating system and inherently demonstrates the true level of economy and competition that should promote and regulate quality information exchange on the Internet.

It is to be understood that the present invention is not limited to the embodiment described above, but encompasses any and all embodiments within the scope of the following claims.

I claim:

1. An interactive knowledge sales market database system, comprising:
a server accessible by a computer network, the server having a processor and computer readable memory in communication with the processor;
a user interface in communication with the processor;
a display in communication with the processor; and
server software stored in the computer readable memory and executable by the processor, the server software having:
advertisement broadcast sub-system means for allowing a remote user to form and store an advertisement for knowledge-based data;
distribution implementation sub-system means for distributing the advertisement on the computer network;
member interaction sub-system means for simulating a virtual marketplace on the computer network; and
economic exchange sub-system means for recording and distributing electronic currency transactions.

2. The interactive knowledge sales market database system as recited in claim 1, further comprising a communications bus for interconnecting the advertisement broadcast sub-system means, the distribution implementation sub-system means, the member interaction sub-system means, and the economic exchange sub-system means.

3. The interactive knowledge sales market database system as recited in claim 2, further comprising a master application sub-system means for selectively starting, stopping and monitoring overall conditions of each of the advertisement broadcast sub-system means, the distribution implementation sub-system means, the member interaction sub-system means, and the economic exchange sub-system means.

4. The interactive knowledge sales market database system as recited in claim 3, further comprising a components manager sub-system means for managing operation of the advertisement broadcast sub-system means, the distribution implementation sub-system means, the member interaction sub-system means, and the economic exchange sub-system means.

5. The interactive knowledge sales market .database system as recited in claim 4, further comprising a market database stored in said computer readable memory.

6. A method of selling knowledge-based data, comprising the steps of:
providing an online database;
forming an advertisement for knowledge-based data and storing the advertisement in the online database;
storing the knowledge-based data in the online database;
distributing the advertisement over a computer network;
receiving payment through the computer network from a purchaser for the knowledge-based data; and
delivering the knowledge-based data to the purchaser via the computer network.

7. The method of selling knowledge-based data as recited in claim 6, further comprising the step of securely logging into the online database.

8. The method of selling knowledge-based data as recited in claim 7, further comprising the step of generating a hyperlink associated with the advertisement, the hyperlink being distributed over the computer network.

9. The method of selling knowledge-based data as recited in claim 8, further comprising the step of displaying to the user a virtual, simulated marketplace environment.
